(19) United States
(12) Patent Application Publication
(10) Pub. No.: US 2017/0277922 A1
(43) Pub. Date: Sep. 28, 2017

(54) MOBILE WIRELESS ANTENNA SYSTEM FOR RFID APPLICATION

(71) Applicants: Tai-Hwa LIU, Hsinchu City (TW); Yi-Chun SUNG, Hsinchu City (TW)

(72) Inventors: Tai-Hwa LIU, Hsinchu City (TW); Yi-Chun SUNG, Hsinchu City (TW)

(21) Appl. No.: 15/082,456

(22) Filed: Mar. 28, 2016

(51) Int. Cl. G06K 7/10; H04B 1/3822

(52) U.S. Cl. CPC G06K 7/10425; H04B 1/3822; G06K 7/10356

(57) ABSTRACT

The present invention provides a mobile wireless antenna system, including: a RFID reader module and a mobile vehicle. The RFID reader module is connected to a first antenna. The mobile vehicle includes a second antenna and a third antenna. The second antenna is connected to the third antenna via a coaxial cable, and the mobile vehicle carries multiple objects that are equipped with RFID tags. As the mobile vehicle moves pass the RFID reader module, a first radio frequency signal is transmitted to the mobile vehicle from the RFID reader module via the first antenna. The mobile vehicle then receives the first radio frequency signal with the second antenna and transmits the first radio frequency signal to the third antenna via the coaxial cable. The first radio frequency signal is transmitted to the RFID tags on the objects from the mobile vehicle via the third antenna.

### BACKGROUND OF THE INVENTION

1. Field of the Invention

The present invention relates to a mobile wireless antenna system, more particularly, relates to a mobile wireless antenna system that combines mobile vehicles with RFID technology.

2. The Prior Arts

As technology advances, various types of machines and equipment have been developed to cope with a need of mass production in the industries. On the production lines of each industry, mobile vehicles have been widely adopted as object conveying means. For example, such mobile vehicles may be the ones often used in the semiconductor industry, such as robotic arms and crown blocks; or, can be the ones adopted in the production lines of various industries, such as automatic guided vehicles and rail cars. Usually, there are several processing procedures in a single industrial production line. When moving from one processing procedure to another, objects on the production line are carried by mobile vehicles. In order to prevent any errors in each processing procedure, mobile vehicles must go through authorization procedures before moving objects from one processing procedure to another.

In conventional authorization procedures, antennas and cables are connected to the mobile vehicles such that the antennas on the mobile vehicles are utilized to authorize or communicate with the tags on various objects. However, because such tags are usually attached to a bottom portion of each object in conventional authorization procedures, antennas often fail to read the tags, thus resulting in a low read rate of the antennas; besides, the attached location of the antennas also makes them vulnerable to interference. Further, it is difficult to control the transmission coverage of conventional antennas and thus it is possible to misread or over-read signals; hence, errors would continue to occur during the manufacturing process in a production line, thereby lowering the productivity. Moreover, the conventional configuration, in which antennas and cables are disposed at the mobile vehicles, requires long cable lines. Since the mobile vehicles are constantly moving, the cables are stretched frequently; consequently, cables are easily damaged as well. On the other hand, a reader is usually disposed on the mobile vehicles in conventional configurations to authorize the tags of objects. Nevertheless, such configuration requires each mobile vehicle to be equipped with a reader. Not only the cost is increased by such configuration, but the power supply of the reader on each mobile vehicle is also a problem.

Based on the above reasons, there is an need for the industry to develop a system such that wireless antennas are disposed on mobile vehicles, and readers at a fixed location communicates and authorizes a tag on an object via the wireless antennas on mobile vehicles.

### SUMMARY OF TEE INVENTION

In view of the drawbacks described above, the present invention provides a mobile wireless antenna system, including: a radio frequency identification module (RFID) reader module and a mobile vehicle. The RFID reader module is connected to a first antenna and includes a power module. The mobile vehicle includes a second antenna and a third antenna. The second antenna is connected to the third antenna via a coaxial cable, and the mobile vehicle carries a plurality of objects. The objects include a plurality of RFID tags, and the RFID tags are configured to correspond to a plurality of object data of the objects. As the mobile vehicle moves pass the RFID reader module, a first radio frequency signal is transmitted to the mobile vehicle from the RFID reader module via the first antenna. The mobile vehicle then receives the first radio frequency signal with the second antenna and transmits the first radio frequency signal to the third antenna via the coaxial cable. The first radio frequency signal is transmitted to the RFID tags on the objects from the mobile vehicle via the third antenna.

Preferably, the second antenna can be placed at an outer side of the mobile vehicle, which is closer to the first antenna, so as to pick up the first radio frequency signal transmitted by the first antenna more easily. The second antenna then transmits the first radio frequency signal to the third antenna via the coaxial cable. The third antenna can be placed at an inner side of the mobile vehicle, which is closer to the RFID tags and is a location that is more readable. If the mobile vehicle is a closed vehicle (provided with a lid), the system provided by the present invention may further isolate the tag on one mobile vehicle from the tags on the other mobile vehicles, thereby lowering the frequency of over-reading.

Preferably, the shielding effect of the vehicles can be eliminated effectively by the wireless transmission between the first antenna and the second antenna, the wired transmission via the coaxial cable between the second antenna and the third antenna, and the wireless transmission between the third antenna and the RFID tags on the objects. In such a way, the transmission effect of radio frequency signals is not compromised by the mobile vehicle.

Preferably, once the RFID tags on the objects receive the first radio frequency signal, the RFID tags transmit a second radio frequency signal, which stores the object data, to the third antenna. The third antenna receives the second radio frequency signal and transmits the second radio frequency signal to the second antenna via the coaxial cable. The mobile vehicle transmits the second radio frequency signal to the first antenna via the second antenna, and, the RFID reader module receives and reads the object data in the second radio frequency signal via the first antenna.

Preferably, the second antenna and the third antenna are disposed on a left side and a right side of the mobile vehicle, respectively.

Preferably, the second antenna is disposed at one of a left side and a right side of the mobile vehicle, and the third antenna is disposed at a roof portion of the mobile vehicle.

Preferably, the RFID tags are disposed at a bottom portion of each of the objects, and the third antenna is disposed under the objects and the RFID tags.

Preferably, the mobile vehicle is one of a service wagon, a semiconductor device conveyor, a rail car, a crown block, a robotic arm and an automatic guided vehicle.

Preferably, the coaxial cable and the third antenna connected thereto as a whole may be replaced with a surface-enhanced waveguide coaxial cable.

Preferably, the first antenna, the second antenna and the third antenna are embedded antennas.

Preferably, the first antenna, the second antenna and the third antenna are one of a microstrip line antenna, a dipole antenna, a slot antenna, a patch antenna and a leaky wave antenna, respectively. Alternatively, the antennas are a combination thereof.

Preferably, the first antenna is disposed on a semiconductor processing machine or at an access checkpoint.

### BRIEF DESCRIPTION OF THE DRAWINGS

Other purposes, advantages and innovative features of the present invention will be apparent to those skilled in the art by reading the following examples with reference to the appended drawings.

FIG. 1 is a block diagram illustrating a configuration of a mobile wireless antenna system in accordance with a first embodiment of the present invention;

FIG. 2 is a schematic view illustrating a configuration of the mobile wireless antenna system in accordance with a second embodiment of the present invention;

FIG. 3 is a schematic view illustrating a mobile vehicle and objects in accordance with one embodiment of the present invention;

FIG. 4 is a top view illustrating a configuration of the mobile wireless antenna system in accordance with a third embodiment of the present invention; and

FIG. 5 is a top view illustrating a configuration of the mobile wireless antenna system in accordance with a fourth embodiment of the present invention.

### DETAILED DESCRIPTION OF THE PREFERRED EMBODIMENT

The accompanying drawings are included to provide a further understanding of the invention, and are incorporated in and constitute a part of this specification. Similar or identical elements are given the same reference numbers. For the sake of simplicity, the figures are not drawn to scale.

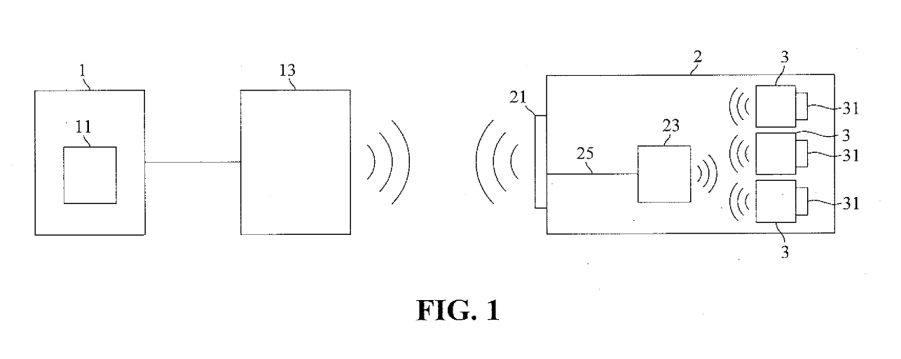

FIG. 1 is a block diagram illustrating a configuration of a mobile wireless antenna system in accordance with a first embodiment of the present invention. Referring to FIG. 1, the mobile wireless antenna system according to the first embodiment of the present invention includes a radio frequency identification (RFID) reader module 1 and a mobile vehicle 2. The RFID reader module 1 is connected to a first antenna 13 and includes a power module 11. The power module 11 is configured to supply power to the RFID reader module 1. The mobile vehicle 2 includes a second antenna 21 and a third antenna 23. The second antenna 21 and the third antenna 23 are connected with each other via a coaxial cable 25. The mobile vehicle 2 carries a plurality of objects 3. These objects 3 can be carried on any positions on the mobile vehicles, for example, objects 3 may be placed inside or on the mobile vehicle 2. The objects 3 include a plurality of RFID tags 31, which are configured to correspond to a plurality of object data of the objects 3. A first radio frequency signal is transmitted to the mobile vehicle 2 from the RFID reader module 1 via the first antenna 13. The mobile vehicle 2 then receives the first radio frequency signal with the second antenna 21 and transmits the first radio frequency signal to the third antenna 23 via the coaxial cable 25. Subsequently, the first radio frequency signal is transmitted to the RFID tags 31 on the objects 3 from the mobile vehicle 2 via the third antenna 23. Once the RFID tags 31 on the objects 3 receive the first radio frequency signal, the RFID tags 31 transmit a second radio frequency signal, which stores the object data, to the third antenna 23. The third antenna 23 receives the second radio frequency signal and transmits the second radio frequency signal to the second antenna 21 via the coaxial cable 25. The mobile vehicle 2 transmits the second radio frequency signal to the first antenna 13 via the second antenna 21, and, the RFID reader module 1 receives and reads the object data in the second radio frequency signal via the first antenna 13. As described above, the first embodiment of the present invention is able to achieve wireless transmission between the RFID reader module 1 and mobile vehicle 2. In the first embodiment of the present invention, the second antenna 21 and the third antenna are disposed at a left side and a right side of the mobile vehicle 2, respectively. In addition, the second antenna is placed at an outer side of the mobile vehicle 2, which is a position closer to the first antenna 13; in such a way, the second antenna 21 may pick up the first radio frequency signal transmitted by the first antenna 13 more easily. The first radio frequency signal picked up by the second antenna 21 is then transmitted to the third antenna 23 via the coaxial cable 25. The third antenna 23 of the mobile vehicle 2 may be disposed at an inner side of the mobile vehicle 2, which is closer to the RFID tags and is a location that is more readable. If the mobile vehicle 2 is a closed vehicle (provided with a lid), the mobile wireless antenna system provided by the present invention may isolate the tag on one mobile vehicle from the tags on the other mobile vehicles, thereby lowering the chance of over-reading. In other embodiments of the present invention, the second antenna 21 and the third antenna 23 may be disposed at arbitrary positions in correspondence with the objects 3 being carried.

On the other hand, in the first embodiment of the present invention, the second antenna 21 is connected to the third antenna 23 via a coaxial cable 25. In other embodiments of the present invention, the coaxial cable 25 and the third antenna 23 connected thereto as a whole may be replaced by a surface-enhanced waveguide coaxial cable (not shown). In other words, the second antenna 21 may be directly connected to the surface-enhanced waveguide coaxial cable, and the second antenna 21 may communicate with the RFID tags 31 on the objects 3 via the surface-enhanced waveguide coaxial cable. It should be understood that the surface enhanced waveguide coaxial cable itself includes the function of an antenna. The detailed structure and technical effects of the surface-enhanced waveguide coaxial cable can be found in Taiwan Patent No. 1450198 B, which is also applied by the Applicant of the present invention, therefore it will not be described in detail herein. In addition, in the first embodiment of the present invention, the first antenna 13, the second antenna 21 and the third antenna 23 may be embedded antennas. In other embodiments of the present invention, the first antenna 13, the second antenna 21 and the third antenna 23 may be one of a microstrip line antenna, a dipole antenna, a slot antenna, a patch antenna and a leaky wave antenna, respectively. Alternatively, the antennas may be a combination thereof. Further, in the first embodiment of the present invention, the mobile vehicle 2 may be one of a service wagon, a semiconductor device conveyor, a rail car, a crown block, a robotic arm and an automatic guided vehicle.

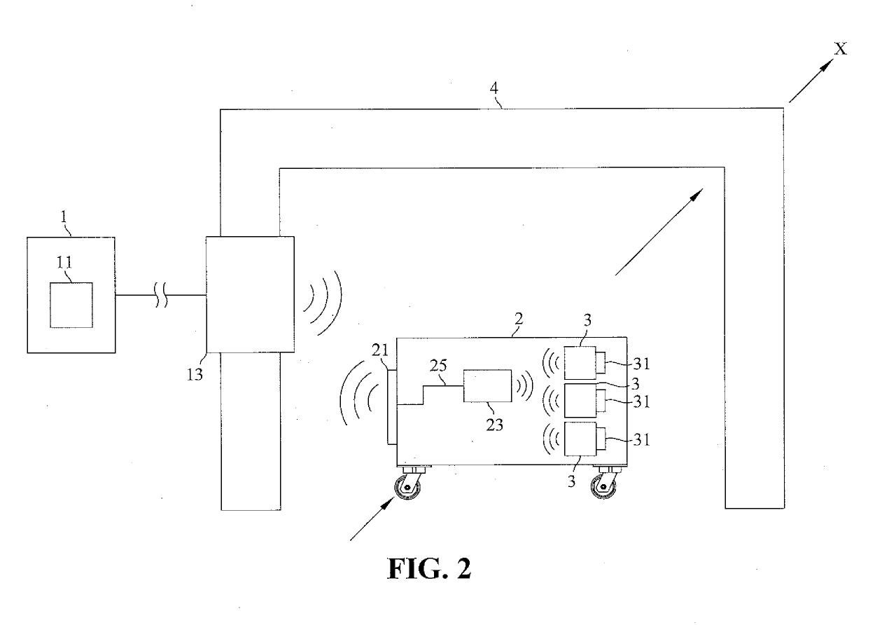

FIG. 2 is a schematic view illustrating a configuration of the mobile wireless antenna system in accordance with a second embodiment of the present invention. As shown in FIG. 2, the mobile wireless antenna system according to the second embodiment of the present invention includes a RFID reader module 1 and a mobile vehicle 2. The RFID reader module 1 is connected to a first antenna 13. The RFID reader module 1 is disposed at an access checkpoint 4 and includes a power module 11. The power module 11 is configured to supply power to the RFID reader module 1. The mobile vehicle 2 includes a second antenna 21 and a third antenna 23. In the second embodiment of the present invention, the second antenna 21 and the third antenna 23 are disposed at a left side and a right side of the mobile vehicle 2, respectively. The second antenna 21 and the third antenna 23 are connected with each other via a coaxial cable 25. In addition, the second antenna 21 is placed at an outer side of the mobile vehicle 2, which is a position closer to the first antenna 13; in such a way, the second antenna 21 may pick up the first radio frequency signal transmitted by the first antenna 13 more easily. The first radio frequency signal picked up by the second antenna 21 is then transmitted to the third antenna 23 via the coaxial cable 25. The third antenna 23 of the mobile vehicle 2 may be disposed at an inner side of the mobile vehicle 2, which is closer to the RFID tags 31 and is a location that is more readable. If the mobile vehicle 2 is a closed vehicle (provided with a lid), the mobile wireless antenna system provided by the present invention may isolate the tag on one mobile vehicle from the tags on the other mobile vehicles, thereby lowering the chance of over-reading. The mobile vehicle 2 carries a plurality of objects 3. These objects 3 can be carried on any positions on the mobile vehicles, for example, objects 3 may be placed inside or on the mobile vehicle 2. The objects 3 include a plurality of RFID tags 31, which are configured to correspond to a plurality of object data of the objects 3. When mobile vehicle 2 moves in a direction X and passes the access checkpoint at which the first antenna 13 is disposed, a first radio frequency signal is transmitted to the mobile vehicle 2 from the RFID reader module 1 via the first antenna 13. The mobile vehicle 2 then receives the first radio frequency signal with the second antenna 21 in a wireless manner and transmits the first radio frequency signal to the third antenna 23 with a wired transmission provided by the coaxial cable 25. Subsequently, the first radio frequency signal is transmitted to the RFID tags 31 on the objects 3 from the mobile vehicle 2 via the third antenna 23. Once the RFID tags 31 on the objects 3 receive the first radio frequency signal, the RFID tags 31 transmit a second radio frequency signal, which stores the object data, to the third antenna 23. The third antenna 23 receives the second radio frequency signal with wireless transmission and transmits the second radio frequency signal to the second antenna 21 via the wired transmission provided by the coaxial cable 25. The mobile vehicle 2 transmits the second radio frequency signal to the first antenna 13 via the second antenna 21, and, the RFID reader module 1 receives and reads the object data in the second radio frequency signal via the first antenna 13. As described above, the second embodiment of the present invention is able to achieve wireless transmission between the RFID reader module 1 and mobile vehicle 2.

On the other hand, in the second embodiment of the present invention, the second antenna 21 is connected to the third antenna 23 via a coaxial cable 25. In other embodiments of the present invention, the coaxial cable 25 and the third antenna 23 connected thereto as a whole may be replaced by a surface-enhanced waveguide coaxial cable (not shown). In other words, the second antenna 21 may be directly connected to the surface-enhanced waveguide coaxial cable, and the second antenna 21 may communicate with the RFID tags 31 on the objects 3 via the surface-enhanced waveguide coaxial cable. It should be understood that the surface-enhanced waveguide coaxial cable itself includes the function of an antenna. In addition, in the second embodiment of the present invention, the first antenna 13, the second antenna 21 and the third antenna 23 may be embedded antennas. In other embodiments of the present invention, the first antenna 13, the second antenna 21 and the third antenna 23 may be one of a microstrip line antenna, a dipole antenna, a slot antenna, a patch antenna and a leaky wave antenna, respectively. Alternatively, the antennas may be a combination thereof. Further, in the second embodiment of the present invention, the mobile vehicle 2 may be one of a service wagon, a semiconductor device conveyor, a rail car, a crown block, a robotic arm and an automatic guided vehicle. Moreover, in the second embodiment of the present invention, the first antenna 13 is disposed at an access checkpoint 4; however, in other embodiments of the present invention, the first antenna 13 may also be disposed on a semiconductor processing machine, so data communication and authorization may be performed between the mobile vehicle 2 and the RFID reader module 1 as the mobile vehicle 2 moves the objects 3 to the semiconductor processing machine.

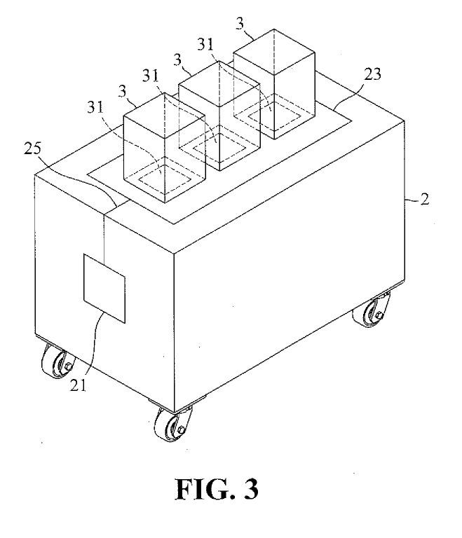

FIG. 3 is a schematic view illustrating the mobile vehicle and objects of the present invention. Referring to FIG. 3, in one embodiment of the present invention, the mobile vehicle 2 includes a second antenna 21 and a third antenna 23. The second antenna 21 is disposed at one of a left side and a right side of the mobile vehicle 2, and the third antenna 23 is disposed at a top portion of the mobile vehicle 2. The second antenna 21 and the third antenna 23 are connected with each other via a coaxial cable 25. In addition, the second antenna 21 is placed at an outer side of the mobile vehicle 2, and the third antenna 23 of the mobile vehicle 2 is disposed at the top portion of the mobile vehicle 2. In such a way, the third antenna 23 is at a location that is closer and more readable to the RFID tags 31. If the mobile vehicle 2 is a closed vehicle (provided with a lid), the mobile wireless antenna system provided by the present invention may isolate the tag on one mobile vehicle from the tags on the other mobile vehicles, thereby lowering the chance of over-reading. The mobile vehicle 2 carries a plurality of objects 3. The objects 3 include a plurality of RFID tags 31, which are configured to correspond to a plurality of object data of the objects 3. The RFID tags 31 are disposed at the bottom portions of the objects 3, and the third antenna 23 is disposed under the objects 3 and RFID tags 31 such that the area of the third antenna 23 may cover all of the objects 3. On the other hand, it should be understood that the mobile vehicle shown in FIG. 3 can be applied in any embodiments of the present invention. In one of the embodiments of the present invention, the mobile vehicle 2 may be one of a service wagon, a semiconductor device conveyor, a rail car, a crown block, a robotic arm and an automatic guided vehicle. Furthermore, in one embodiment of the present invention, the second antenna 21 is connected to the third antenna 23 via a coaxial cable 25. In other embodiments of the present invention, the coaxial cable 25 and the third antenna 23 connected thereto as a whole may be replaced by a surface-enhanced waveguide coaxial cable (not shown). In other words, the second antenna 21 may be directly connected to the surface-enhanced waveguide coaxial cable, and the second antenna 21 may communicate with the RFID tags 31 on the objects 3 via the surface-enhanced waveguide coaxial cable. It should be understood that the surface-enhanced waveguide coaxial cable itself includes the function of an antenna.

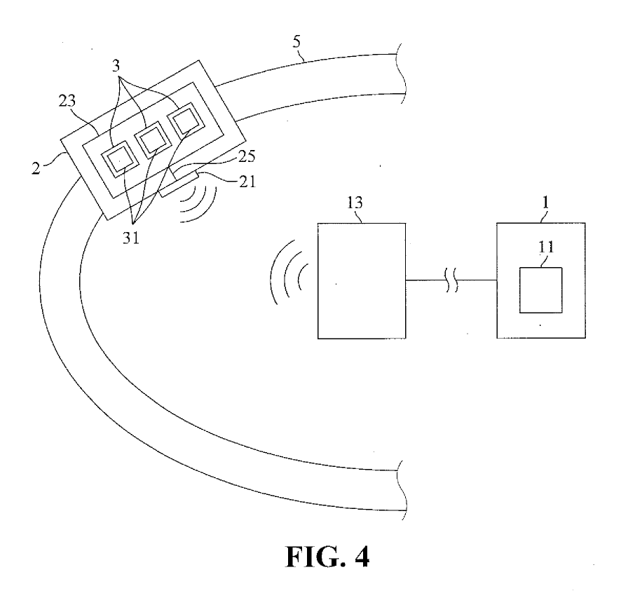

FIG. 4 is a top view illustrating a configuration of the mobile wireless antenna system in accordance with a third embodiment of the present invention. As shown in FIG. 4, the mobile wireless antenna system according to the third embodiment of the present invention includes a RFID reader module 1 and a mobile vehicle 2. The RFID reader module 1 is connected to a first antenna 13. The RFID reader module 1 is disposed at a central position of a rail 5 and includes a power module 11. The power module 11 is configured to supply power to the RFID reader module 1. The mobile vehicle 2 moves along the rail 5, and includes a second antenna 21 and a third antenna 23. In the third embodiment of the present invention, the second antenna 21 is disposed at one of a left side and a right side of the mobile vehicle 2, and the third antenna 23 is disposed at a top portion of the mobile vehicle 2. The second antenna 21 and the third antenna 23 are connected with each other via a coaxial cable 25. The mobile vehicle 2 carries a plurality of objects 3. The objects 3 include a plurality of RFID tags 31, which are configured to correspond to a plurality of object data of the objects 3. As the mobile vehicle 2 moves along the rail 5 and passes the first antenna 13, a first radio frequency signal is transmitted to the mobile vehicle 2 from the RED reader module 1 via the first antenna 13. The mobile vehicle 2 then receives the first radio frequency signal with the second antenna 21 in a wireless manner and transmits the first radio frequency signal to the third antenna 23 with a wired transmission provided by the coaxial cable 25. Subsequently, the first radio frequency signal is transmitted to the RFID tags 31 on the objects 3 from the mobile vehicle 2 via the third antenna 23. Once the RFID tags 31 on the objects 3 receive the first radio frequency signal, the RFID tags 31 transmit a second radio frequency signal, which stores the object data, to the third antenna 23. The third antenna 23 receives the second radio frequency signal with wireless transmission and transmits the second radio frequency signal to the second antenna 21 via the wired transmission provided by the coaxial cable 25. The mobile vehicle 2 transmits the second radio frequency signal to the first antenna 13 via the second antenna 21, and, the RFID reader module 1 receives and reads the object data in the second radio frequency signal via the first antenna 13. As described above, the third embodiment of the present invention is able to achieve wireless transmission between the RFID reader module 1 and mobile vehicle 2.

On the other hand, in the third embodiment of the present invention, the second antenna 21 is connected to the third antenna 23 via a coaxial cable 25. In other embodiments of the present invention, the coaxial cable 25 and the third antenna 23 connected thereto as a whole may be replaced by a surface-enhanced waveguide coaxial cable (not shown). In other words, the second antenna 21 may be directly connected to the surface-enhanced waveguide coaxial cable, and the second antenna 21 may communicate with the RFID tags 31 on the objects 3 via the surface-enhanced waveguide coaxial cable. It should be understood that the surface-enhanced waveguide coaxial cable itself includes the function of an antenna. In addition, in the third embodiment of the present invention, the first antenna 13, the second antenna 21 and the third antenna 23 may be embedded antennas. In other embodiments of the present invention, the first antenna 13, the second antenna 21 and the third antenna 23 may be one of a microstrip line antenna, a dipole antenna, a slot antenna, a patch antenna and a leaky wave antenna, respectively. Alternatively, the antennas may be a combination thereof. Further, in the third embodiment of the present invention, the mobile vehicle 2 may be one of a service wagon, a semiconductor device conveyor, a rail car, a crown block, a robotic arm and an automatic guided vehicle. Moreover, according to the configuration of the third embodiment, the first antenna 13 is disposed on the path of the rail 5, so the mobile vehicle 2 may directly communicate with and be authorized by the RFID reader module 1 via the first antenna 13 as it moves along the rail 5, thus achieving simplification of the work process and the purpose of time-saving.

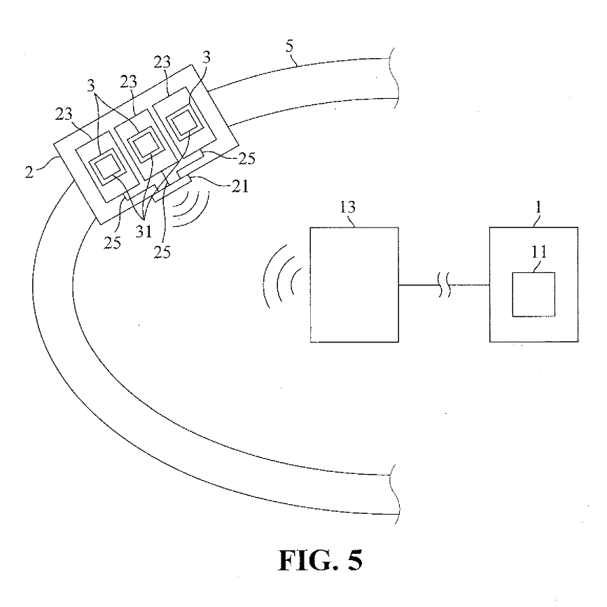

FIG. 5 is a top view illustrating a configuration of the mobile wireless antenna system in accordance with a fourth embodiment of the present invention. As shown in FIG. 5, the mobile wireless antenna system according to the fourth embodiment of the present invention is substantially the same as the one in the third embodiment. The difference between the two lies in that the mobile wireless antenna system according to the fourth embodiment includes a plurality of third antenna 23 and a plurality of coaxial cables 25. The second antenna 21 is connected to the third antennas 23 via the coaxial cables 25. The third antennas 23 are located under the objects 3. As a result, the system may read the RFID tags 31 on the objects 3 in a more effective way.

On the other hand, according to the fourth embodiment, the second antenna 21 is connected to the third antennas 23 via the coaxial cables 25; however, in other embodiments of the present invention, each set of the coaxial cables 25 and the third antennas 23 connected thereto may be replaced by a surface-enhanced waveguide coaxial cable (not shown). In other words, the second antenna 21 may be directly connected to the surface-enhanced waveguide coaxial cable, and the second antenna 21 may communicate with the RFID tags 31 on the objects 3 via the surface-enhanced waveguide coaxial cable. It should be understood that the surface-enhanced waveguide coaxial cable itself includes the function of an antenna. Moreover, the configuration in which the second antenna 21 is connected to the third antennas 23 via the coaxial cables 25 may also be applied to other embodiments of the present invention.

As described above, the present invention provides a mobile wireless antenna system that employs two sets of antennas on a mobile vehicle to achieve wireless communication between a RFID reader and RFID tags disposed on multiple objects. The system provided by the present invention only requires one set of RFID reader. The two sets of antennas on the mobile vehicle may act according to the radio frequency signals transmitted by the RFID reader. As a result, cables, which are attached to the mobile vehicles in the prior arts, are not required anymore to connect directly with the antenna, thereby saving costs and simplifying the configuration of the system. In addition, if the mobile vehicle is a closed vehicle (provided with a lid), the mobile wireless antenna system provided by the present invention may isolate the tag on one mobile vehicle from the tags on the other mobile vehicles, thereby lowering the chance of over-reading. Further, the shielding effect of the vehicles can be eliminated effectively by the wireless transmission between the first antenna and the second antenna, the wired transmission provided by the coaxial cable between the second antenna and the third antenna, and the wireless transmission between the third antenna and the RFID tags on the objects. In such a way, the transmission effect of radio frequency signals is not compromised by the mobile vehicle,

Although the methods/processes according to the embodiments of the present invention have been described in a certain order, it is not meant to limit the order of the steps. It should be apparent to those with ordinary skills in the art that the methods/processes can also be performed in a different order. Therefore, the order of the steps should not be seen as a limitation to the claims of the present invention. In addition, the methods/processes in the claims should not be limited by the order of steps described above. Those who are skilled in the art should understand that the order of the steps can be changed without departing from the scope of the present invention.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A mobile wireless antenna system, comprising:
a radio frequency identification module (RFID) reader module connected to a first antenna, wherein the RFID reader module includes a power module; and
a mobile vehicle having a second antenna and a third antenna, wherein the second antenna is connected to the third antenna via a coaxial cable, and the mobile vehicle carries a plurality of objects, wherein the objects include a plurality of RFID tags, and the RFID tags are configured to correspond to a plurality of object data of the objects;
wherein as the mobile vehicle moves pass the RFID reader module, a first radio frequency signal is transmitted to the mobile vehicle from the RFID reader module via the first antenna, the mobile vehicle receives the first radio frequency signal with the second antenna and transmits the first radio frequency signal to the third antenna via the coaxial cable, and, the first radio frequency signal is transmitted to the RFID tags on the objects from the mobile vehicle via the third antenna.

2. The mobile wireless antenna system according to claim 1, wherein as the RFID tags on the objects receive the first radio frequency signal, the RFID tags transmit a second radio frequency signal, which stores the object data, to the third antenna, the third antenna receives the second radio frequency signal and transmits the second radio frequency signal to the second antenna via the coaxial cable, the mobile vehicle transmits the second radio frequency signal to the first antenna via the second antenna, and, the RFID reader module receives and reads the object data in the second radio frequency signal via the first antenna.

3. The mobile wireless antenna system according to claim 1, wherein the second antenna and the third antenna are disposed on a left side and a right side of the mobile vehicle, respectively.

4. The mobile wireless antenna system according to claim 1, wherein the second antenna is disposed at one of a left side and a right side of the mobile vehicle, and the third antenna is disposed at a roof portion of the mobile vehicle.

5. The mobile wireless antenna system according to claim 1, wherein the RFID tags are disposed at a bottom portion of each of the objects, and the third antenna is disposed under the objects and the RFID tags.

6. The mobile wireless antenna system according to claim 1, wherein the mobile vehicle is one of a service wagon, a semiconductor device conveyor, a rail car, a crown block, a robotic arm and an automatic guided vehicle.

7. The mobile wireless antenna system according to claim 1, wherein the coaxial cable and the third antenna connected thereto as a whole may be replaced with a surface-enhanced waveguide coaxial cable.

8. The mobile wireless antenna system according to claim 1, wherein the first antenna, the second antenna and the third antenna are embedded antennas.

9. The mobile wireless antenna system according to claim 1, wherein the first antenna, the second antenna and the third antenna are one of a microstrip line antenna, a dipole antenna, a slot antenna, a patch antenna and a leaky wave antenna, respectively, or are a combination thereof.

10. The mobile wireless antenna system according to claim 1, wherein the first antenna is disposed on a semiconductor processing machine or at an access checkpoint.
